(19) United States
(12) Patent Application Publication
(10) Pub. No.: US 2015/0363578 A1
(43) Pub. Date: Dec. 17, 2015

(54) AUTOMATED POPULARITY-BASED PRICING FOR DIGITAL CONTENT LICENSING

(71) Applicant: Altair Engineering, Inc., Troy, MI (US)

(72) Inventors: Massimo Fariello, Turin (IT); Stephanie Scapa, Menlo Park, CA (US); Srikanth Mahalingam, Troy, MI (US)

(21) Appl. No.: 14/447,989

(22) Filed: Jul. 31, 2014

Related U.S. Application Data
(60) Provisional application No. 62/012,554, filed on Jun. 16, 2014.

(51) Int. Cl. G06F 21/10

(52) U.S. Cl. CPC G06F 21/105; G06F 2221/0775

(57) ABSTRACT

A method and apparatus for automated popularity-based pricing for digital content licensing are provided. Automated popularity-based pricing for digital content licensing may include receiving a request for access to content, the request for access indicating a customer account, determining a cardinality of assigned units for the content based on a popularity based assignment index for the content, identifying a cardinality of available licensing units allocated to the customer account, determining whether the cardinality of the assigned units is within the cardinality of the available licensing units, outputting a response indicating that the request is granted, on a condition that the cardinality of the assigned units is within the cardinality of the available licensing units, and outputting a response indicating that the request is denied, on a condition that the cardinality of the assigned units exceeds the cardinality of the available licensing units.

### CROSS-REFERENCE TO RELATED APPLICATIONS

This application claims priority to U.S. Provisional Patent Application No. 62/012,554, filed on Jun. 16, 2014, which is incorporated by reference in its entirety herein.

### TECHNICAL FIELD

The present disclosure relates to systems and methods of licensing access to digital content.

### BACKGROUND OF THE DISCLOSURE

Digital content such as computer software products, video games, music, and any other media capable of being embodied in digital format may be sold or licensed to an end user customer. For example, the right to copy, access, or execute the digital content may be licensed to a user and a provider or vendor may retain ownership of the rights to the content. Accordingly, it may be desirable to provide automated popularity-based pricing for digital content licensing.

### SUMMARY OF THE DISCLOSURE

Disclosed herein are aspects, features, elements, implementations, and embodiments of automated popularity-based pricing for digital content licensing.

In an embodiment, a method of automated popularity-based pricing for digital content licensing is disclosed. Automated popularity-based pricing for digital content licensing may include receiving a request for access to content, the request for access indicating a customer account, determining a cardinality of assigned units for the content based on a popularity based assignment index for the content, identifying a cardinality of available licensing units allocated to the customer account, determining whether the cardinality of the assigned units is within the cardinality of the available licensing units, outputting a response indicating that the request is granted, on a condition that the cardinality of the assigned units is within the cardinality of the available licensing units, and outputting a response indicating that the request is denied, on a condition that the cardinality of the assigned units exceeds the cardinality of the available licensing units.

In another embodiment, an apparatus for automated popularity-based pricing for digital content licensing is disclosed. The apparatus may include a non-transitory computer readable memory and a processor configured to execute instructions stored on the memory to receive a request for access to content, the request for access indicating a customer account, determine a cardinality of assigned units for the content based on a popularity based assignment index for the content, identify a cardinality of available licensing units allocated to the customer account, determine whether the cardinality of the assigned units is within the cardinality of the available licensing units, output a response indicating that the request is granted, on a condition that the cardinality of the assigned units is within the cardinality of the available licensing units, and output a response indicating that the request is denied, on a condition that the cardinality of the assigned units exceeds the cardinality of the available licensing units.

In another embodiment, a method of automated popularity-based pricing for digital content licensing is disclosed. Automated popularity-based pricing for digital content licensing may include transmitting a request for access to content, the request for access indicating a customer account, receiving a response, identifying, in the response, an indication that the request is granted, on a condition that a cardinality of assigned units for the content is within a cardinality of available licensing units allocated to the customer account, wherein the cardinality of the assigned units for the content is based on a popularity based assignment index.

Variations in these and other aspects, features, elements, implementations, and embodiments of the methods, apparatus, procedures, and algorithms disclosed herein are described in further detail hereafter.

### BRIEF DESCRIPTION OF THE DRAWINGS

The description herein makes reference to the accompanying drawings wherein like reference numerals refer to like parts throughout the several views, and wherein:

FIG. 1 is a diagram of an example of a communication system for automated popularity-based pricing for digital content licensing in accordance with embodiments of this disclosure; and

FIG. 2 is a flow diagram of an example of digital content licensing using automated popularity-based pricing in accordance with embodiments of this disclosure;

FIG. 3 is a flow diagram of an example of accessing digital content using automated popularity-based pricing for digital content unit-based licensing in accordance with embodiments of this disclosure;

FIG. 4 is a flow diagram of an example of automated popularity-based pricing for digital content licensing in accordance with embodiments of this disclosure; and

FIG. 5 is a graph showing an example of a relationship between assigned units and an assignment index in accordance with embodiments of this disclosure.

### DETAILED DESCRIPTION

A creator or owner of content, such as digital content or live-performance content, may control access to the content by licensing the content to end users. For example, licensing may include controlling the right to display, perform, distribute, or reproduce the content. Unit-based licensing may include licensing that controls access to content by allocating licensing units to a customer account, such that one or more licensing units may be redeemed or charged to access one or more digital content objects.

Automated popularity-based pricing for digital content licensing may include allocating licensing units to a user, or customer, such that the user may redeem or charge one or more licensing units to access one or more digital content objects. In some embodiments, licensing prices, which may indicate the number of licensing units associated with accessing particular digital content objects, may be automatically determined based on popularity measures for the particular digital content being accessed. In some embodiments, pricing may be determined, at least in part, based on pricing metrics, such as a popularity index. In some embodiments, a popularity index may be determined based on popularity factors, such as the number of times the digital content object has been accessed and how recent the digital content is. In some embodiments, automated popularity-based pricing for digital content licensing may include licensing for a single customer or for a customer group, wherein multiple group members may share licensing units.

The aspects, features, elements, and embodiments of methods, procedures, or algorithms disclosed herein, or any part or parts thereof, may be implemented in a computer program, software, or firmware incorporated in a non-transitory computer-readable storage medium for execution by a general purpose or special purpose computer or processor, and may be implemented as a computer program product, such as a computer program product accessible from a tangible computer-usable or computer-readable medium.

As used herein, the terminology “computer” or “device” includes any unit, or combination of units, capable of performing any method, or any portion or portions thereof, disclosed herein. Devices may further include mobile devices that may include user equipment, a wireless transmit/receive unit, a mobile station, a fixed or mobile subscriber unit, a pager, a cellular telephone, a personal digital assistant (PDA), a computer, or any other type of user device capable of operating in a mobile environment.

As used herein, the terminology “processor” includes a single processor or multiple processors, such as one or more general purpose processors, one or more special purpose processors, one or more conventional processors, one or more digital signal processors, one or more microprocessors, one or more controllers, one or more microcontrollers, one or more Application Specific Integrated Circuits (ASICs), one or more Application Specific Standard Products (ASSPs); one or more Field Programmable Gate Arrays (FPGAs) circuits, any other type or combination of integrated circuits (ICs), one or more state machines, or any combination thereof.

As used herein, the terminology “memory” includes any computer-usable or computer-readable medium or device that can, for example, tangibly contain, store, communicate, or transport any signal or information for use by or in connection with any processor. Examples of computer-readable storage mediums may include one or more read only memories, one or more random access memories, one or more registers, one or more cache memories, one or more semiconductor memory devices, one or more magnetic media, such as internal hard disks and removable disks, one or more magneto-optical media, one or more optical media such as CD-ROM disks, and digital versatile disks (DVDs), or any combination thereof.

As used herein, the terminology “example”, “embodiment”, “implementation”, “aspect”, “feature”, or “element” indicate serving as an example, instance, or illustration. Unless expressly indicated, any example, embodiment, implementation, aspect, feature, or element is independent of each other example, embodiment, implementation, aspect, feature, or element and may be used in combination with any other example, embodiment, implementation, aspect, feature, or element.

As used herein, the terminology “determine” and “identify”, or any variations thereof, includes selecting, ascertaining, computing, looking up, receiving, determining, establishing, obtaining, or otherwise identifying or determining in any manner whatsoever using one or more of the devices shown and described herein. As used herein, the terminology “cardinality” includes a number or count of elements or items in a set, group, plurality, or any other collection of zero or more elements.

As used herein, the terminology “or” is intended to mean an inclusive “or” rather than an exclusive “or”. That is, unless specified otherwise, or clear from context, “X includes A or B” is intended to indicate any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form.

As used herein, the terminology “digital content” may include computer software programs, video games, music, movies, videos, or any other media that may be embodied in digital form, and which may be accessed, downloaded, input, or otherwise transferred to a computer or processor. Digital content may include digital data or digital files that may be processed by external application programs or may be executed by external software, hardware, or both. As used herein, the terminology “content” may include live content or fixed content. Fixed content may include any content that may be presented from a tangible storage medium, such as digital content. Live content, or live-performance content, may include any content that may be accessed substantially concurrently with the creation or generation of the content, such as the presentation of a movie in a movie theater, a concert, a sporting event, a gallery display, or any other live event.

As used herein, the terminology “event” may include any presentation, distribution, or display of content capable of concurrent, or nearly concurrent, access by multiple users. For example, an event may include a physical presentation, such a presentation at a movie theater, concert hall, museum, or restaurant, or a virtual presentation, such as a broadcast over the Internet or a television broadcast. Although described as automated popularity-based pricing for digital content licensing, implementations of this disclosure may apply to automated popularity-based pricing for digital content licensing.

As used herein, the terminology “access” or “accessing” may include presenting, downloading, executing, streaming, or otherwise interacting, or enabling interaction, with a content object. In some embodiments, digital content objects may be executed, stored, or both, at a provider location. In some embodiments, digital content objects may be stored locally on a customer network or customer device and the digital content objects may be executed or run on the customer network or device.

In some embodiments, a node based license may indicate that content is accessible by a unique device, such as a computer, a unique account, such as an account associated with an individual user, or a combination of a unique device and a unique account. In some embodiments, a network based license may indicate that content is accessible by one or more devices within a specified network. For example, a defined number of devices within the network may concurrently access the content. In some embodiments, a license, including a node based license or a network based license, may be associated with a unique content object, or with a suite of related content objects.

As used herein, the terminology “assigned units”, “price”, “licensing price” or variations thereof, may include an assigned number of licensing units that may be exchanged or redeemed to access a particular content object. As used herein, the terminology “licensed units” or “allocated units” may refer to a total number of units provided to a customer or customer group. As used herein, the terminology “checked out units”, “redeemed units”, or “exchanged units” may refer to assigned units charged to a customer for digital content being accessed. “Available units” may refer to a difference between licensed units and checked out units. In some embodiments, licensing units may be temporarily or permanently exchanged for access. Temporarily exchanged licensing units may be returned to the pool of available units associated with the customer upon termination or completion of content access.

Further, for simplicity of explanation, although the figures and descriptions herein may include sequences or series of steps or stages, elements of the methods disclosed herein may occur in various orders or concurrently. Additionally, elements of the methods disclosed herein may occur with other elements not explicitly presented and described herein. Furthermore, not all elements of the methods described herein may be required to implement a method in accordance with this disclosure. Although aspects, features, and elements are described herein in particular combinations, each aspect, feature, or element may be used independently or in various combinations with or without other aspects, features, and elements.

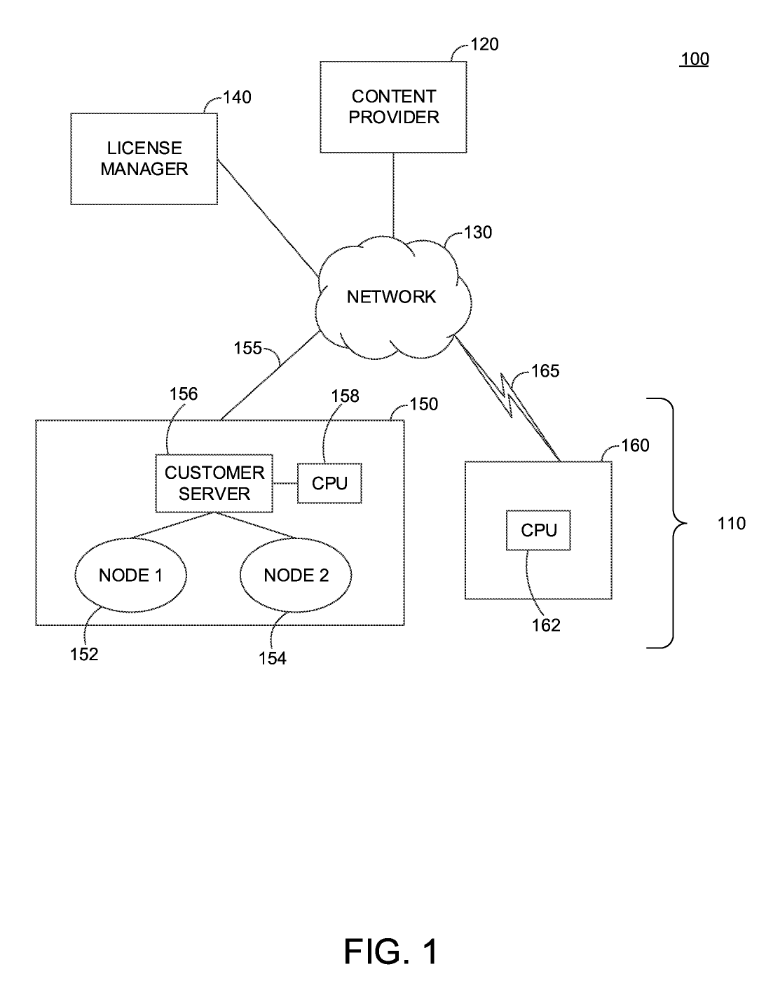

FIG. 1 is a diagram of an example of a communication system 100 for unit-based licensing for digital content access in accordance with embodiments of this disclosure. For simplicity, the communication system 100 shown in FIG. 1 includes a customer system 110, a provider 120, a network 130, and a license manager 140; however, other elements, such as multiple networks, access points, or communication mediums may be included in a communication system for unit-based licensing for digital content access.

In some embodiments, customer system 110 may be associated with an individual user or customer, and the user may access content using licensing units allocated to the user. In some embodiments, customer system 110 may comprise devices and networks through which a customer or user may access digital content from provider 120. For example, as shown in FIG. 1, customer system 110 may include a customer network 150 and a customer device 160; however, any number of customer networks and customer devices may be used.

In some implementations, customer system 110 may be associated with a collection or group of customers, or members, and shared licensing units may be allocated to the group. For example, a group may include one or more families, a classroom of students, a small business, a social group, or any other organization capable of licensing content such that members of the group are capable of accessing the content.

In some embodiments, elements of the customer system 110, such as customer network 150 and customer device 160, may communicate with each other or with elements external to the customer system 110, such as the provider 120. For example, customer network 150 and customer device 160 may independently communicate through communication network 130.

In some embodiments, customer network 150 may include one or more individual nodes 152/154, a customer server 156, a host processor (CPU) 158, or any combination thereof. A node 152/154 may be a device, such as a computer, and may access digital content. For example, a node 152/154 may access digital content in response to user input. Although FIG. 1 includes a first node 152 and a second node 154 for simplicity, any number of nodes may be used. In some embodiments, a node 152/154 may be connected to a customer server 156 and may have a unique network address. In some embodiments, a node 152/154 may communicate with other nodes 152/154 within customer network 150. The customer server 156 may communicate with CPU 158. Although individual nodes 152/154 are depicted as being connected in a spoke configuration to the customer server 156, the individual nodes 152/154 may be connected in any other electronic computer network configuration. Although shown as separate units, in some embodiments, customer server 156 and CPU 158 may be combined into a single device.

In some embodiments, customer device 160 may be any device, such as a computer or mobile device, capable of accessing digital content. In some embodiments, a customer device 160 may include a processor, such as CPU 162.

In some embodiments, provider 120 may be a device or system configured to provide access to digital content to one or more licensed customers. For example, provider 120 may include an Internet Protocol (IP) network-based unit, such as a website service, that implements methods for controlling access to digital content. In some embodiments, provider 120 may provide customer system 110 access to digital content objects, which may be included in a suite of digital content. Although FIG. 1 shows the provider 120 as a single unit, the provider 120 may include any number of discrete units and any number of providers 120 may be used.

In some implementations, unit-based licensing for digital content may include communication between the customer system 110 and the provider 120 via the communication network 130. The communication network 130 may be a local area network (LAN), wide area network (WAN), virtual private network (VPN), a mobile or cellular telephone network, the Internet, or any other electronic communication medium. Although not explicitly shown in FIG. 1, each of the customer system 110, provider 120, and license manager 140 may communicate with communication network 130 through one or more Internet service providers (ISPs). In some embodiments, the customer network 150, the customer device 160, or both, may communicate with the network 130 via a wired connection 155 a wireless connection 165, or a combination of one or more wired or wireless connections.

In some embodiments, a license manager (LM) 140 may be included in the communication system 100. License manager 140 may control the access to digital content provided by provider 120. Although shown as a separate unit, in some embodiments, license manager 140 may be incorporated with provider 120, customer system 110, or both. In some embodiments, the license manager 140 may monitor content access for the customer system 110. For example, the license manager 140 may detect the termination or conclusion of access to content.

In some embodiments, license manager 140 may generate and maintain a log. The log may include a record of a number of available units that may be used by the customer system 110 at any given time. In some embodiments, the license manager 140 may update the log for each change of the available units for customer system 110. For example, the log may be updated to indicate a change in the available units in response to the accessing of digital content from provider 120, the termination of the access of digital content, or a change in pricing of digital content being accessed by the customer. In some embodiments, the log may be a file, or database, stored in a memory in communication with provider 120 or license manager 140.

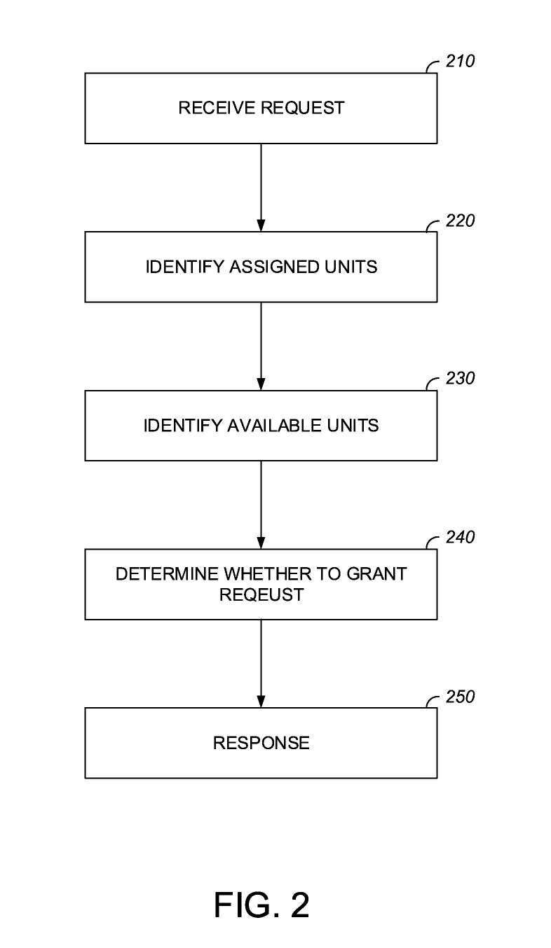

FIG. 2 is a flow diagram of an example of digital content licensing using automated popularity-based pricing in accordance with embodiments of this disclosure. Automated popularity-based pricing for digital content licensing may include temporarily or permanently exchanging licensing units for access to content, such as digital content. In some embodiments, automated popularity-based pricing for digital content licensing may be implemented in a communication system, such as the communication system 100 shown in FIG. 1.

In some embodiments, automated popularity-based pricing for digital content licensing may include receiving a request to access a digital content object at 210, identifying an amount of assigned units for the digital content object at 220, identifying an amount of available units 230, determining whether to grant the request at 240, responding to the request at 250, or a combination thereof.

In some embodiments, a request to access content may be received at 210. For example, a provider, such as the provider 120 shown in FIG. 1, may receive the request from a customer, such as the customer system 110 shown in FIG. 1, via a network, such as the network 130 shown in FIG. 1. In some embodiments, the request may indicate a selected digital content object. In some embodiments, the request to access content may include information identifying the customer, such as account information associated with the customer system.

In some embodiments, assigned license units for the selected digital content may be identified at 220. In some embodiments, the number of assigned units for a digital content object may remain constant or may vary over time. In some embodiments, the assigned units for each digital content object may be based upon popularity measures. In some embodiments, a license manager, such as the license manager 140 shown in FIG. 1, may identify the assigned license units for the selected digital content. In some embodiments, the license manager may be independent of the provider, and the license manager may receive the request via the customer system or via the provider.

In some embodiments, a number or cardinality of available units associated with the customer system may be determined at 230. The available units may indicate a number of licensing units that may be used by the customer system at a given time, such as at the time the request is received. For example, although not shown in FIG. 2, one or more licensing units may be allocated or licensed to the customer system, one or more of the allocated units may be temporarily or permanently exchanged or checked out for access to content, and the number of available units may indicate the difference between the number of allocated units and the number of checked out units.

In some embodiments, subgroups may be identified within the customer system and a portion of the available units associated with the customer system may be allocated to each respective subgroup. For example, the nodes 152/154 shown in FIG. 1 may be included in a first subgroup, and the customer device 160 shown in FIG. 1 may be include in a second subgroup.

In some embodiments, whether to grant access may be determined at 240. For example, determining whether to grant access at 240 may include determining whether the count of available units for the customer or the customer subgroup is equal to or greater than the number of assigned units for the digital content.

In some embodiments, a response may be output at 250. For example, the provider or licensing manager may generate a response indicating that the request for access is granted or denied and may transmit the response to the requesting device, the customer system, or both.

In some embodiments, the request for access may be denied. For example, the number of available units associated with the customer or the customer subgroup may be less than the number of assigned units for the requested digital content and the request may be denied. In some embodiments, the provider may reject the request and may prevent the customer system, the requesting device, or both, from accessing to the content.

In some embodiments, the request for access may be granted. For example, the number of available units associated with the customer or the customer subgroup may be equal to or greater than the number of assigned units for the requested digital content and the request may be granted.

Although not shown separately, in some embodiments, granting the request may include charging, redeeming, or exchanging a number of available licensing units allocated to the customer system or the customer subgroup corresponding to the number of assigned units for the digital content object. For example, the license manager or provider may record the number of licensing units charged, may update the number available units associated with the customer system or the customer subgroup, or both. In some embodiments, the license manager or provider may record any change in charged units or available units in a log. In some embodiments, the number of available units for the customer system or the customer subgroup may be decreased in an amount equal to the number of assigned units for the digital content indicated in the request.

In some embodiments, granting the request may include determining whether to charge one or more of the available licensing units allocated to the customer system or the customer subgroup. For example, the provider or the licensing manager may determine the number of checked out units currently charged against the customer system or the customer subgroup, and may determine a number of licensing units to charge against the customer system or the customer subgroup based on a difference between the number of assigned units for the requested content and the number of currently checked out units for the customer or the customer subgroup. For example, the number of currently checked out units for the customer or the customer subgroup may be greater than the number of assigned units and granting the request may omit checking out available units. In another example, the number of currently checked out units for the customer or the customer subgroup may be less than the number of assigned units and granting the request may include checking out a number of available units equal to the difference between the number of assigned units and the number of currently checked out units.

Although not shown separately, in some embodiments, a device may access the digital content in response to receiving a response granting the request. For example, the device may receive the requested content from the provider via the customer system. In some embodiments, the available units for the customer or the customer subgroup may be updated in response to the device accessing the content.

Although not shown separately, in some embodiments, the number of charged units may be returned to the customer system or the customer subgroup upon completion or termination of the access of the digital content.

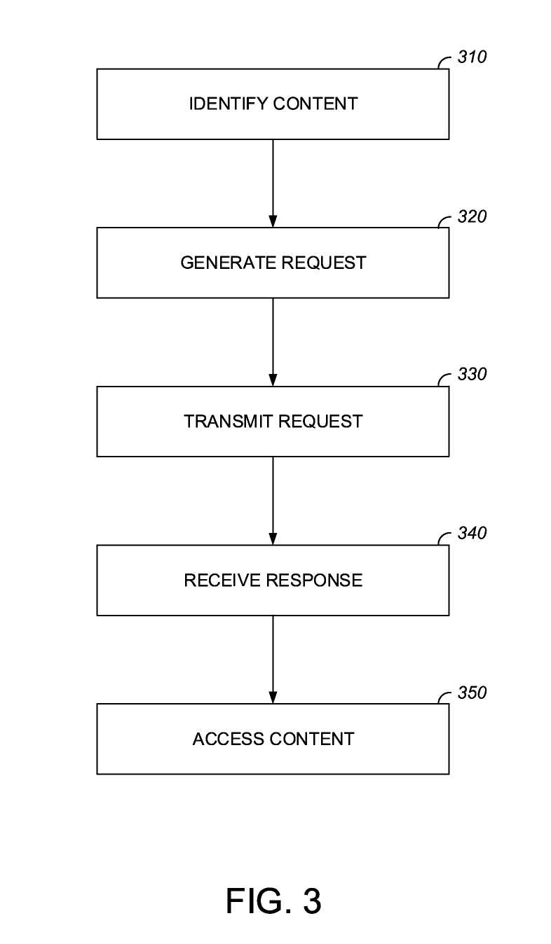

FIG. 3 is a flow diagram of an example of accessing digital content using automated popularity-based pricing for digital content unit-based licensing in accordance with embodiments of this disclosure. Accessing digital content using automated popularity-based pricing for digital content unit-based licensing may include temporarily or permanently exchanging licensing units for access to content, such as digital content. In some embodiments, accessing digital content using automated popularity-based pricing for digital content unit-based licensing may be implemented in a communication system, such as the communication system 100 shown in FIG. 1.

In some embodiments, accessing digital content using automated popularity-based pricing for digital content unit-based licensing may include identifying a digital content object at 310, generating a request to access the digital content object at 320, transmitting the request to access the digital content object at 330, receiving a response to the request at 340, accessing the digital content object at 350, or a combination thereof.

In some embodiments, a digital content object may be identified at 310. For example, identifying the digital content object may include identifying a computer software program, video game, music, a movie, a video, or any other media that may be embodied in digital form, and may be accessed, downloaded, input, or otherwise transferred to a computer or processor. In some embodiments, identifying a digital content object may include identifying a plurality of digital content objects.

In some embodiments, a request to access the identified digital content object may be generated at 320. In some embodiments, the request may indicate the digital content object identified at 310. In some embodiments, the request to access content may include information identifying the customer, such as account information associated with the customer system, and may include information identifying the device accessing the content or a user accessing the content, such as an identifier of the device 160 shown in FIG. 1. For example, the customer system may include a network, such as a wireless network, and the accessing device may connect to the network and may send a request to access content to the provider via the network of the customer system.

In some embodiments, a request to access the identified digital content object may be transmitted at 330. For example, a requesting device, such as the device 160 shown in FIG. 1, may transmit the request to a provider, such as the provider 120 shown in FIG. 1, via a customer, such as the customer system 110 shown in FIG. 1. Although the device 160 is shown in FIG. 1 as communicating via the customer system, the device may communicate via a third party network, such as the network 130 shown in FIG. 1.

In some embodiments, a response to the request may be received at 340. For example, the provider or licensing manager may generate a response indicating that the request for access is granted or denied and may transmit the response to the requesting device, the customer system, or both.

In some embodiments, the response may indicate whether the request is granted or denied. In some embodiments, whether the request is granted or denied may depend on a count or cardinality of assigned license units for the selected digital content. In some embodiments, the number of assigned units for a digital content object may remain constant or may vary over time. In some embodiments, a license manager, such as the license manager 140 shown in FIG. 1, may identify the assigned license units for the selected digital content. In some embodiments, the license manager may be independent of the provider, and the license manager may receive the request via the customer system or via the provider.

In some embodiments, whether the request is granted or denied may depend on a count or cardinality of available licensing units associated with the customer system. The available units may indicate a number of licensing units that may be used by the customer system at a given time, such as at the time the request is received. For example, although not shown in FIG. 2, one or more licensing units may be allocated or licensed to the customer system, one or more of the allocated units may be temporarily or permanently exchanged or checked out for access to content, and the number of available units may indicate the difference between the number of allocated units and the number of checked out units.

In some embodiments, subgroups may be identified within the customer system and a portion of the available units associated with the customer system may be allocated to each respective subgroup. For example, the nodes 152/154 shown in FIG. 1 may be included in a first subgroup, and the customer device 160 shown in FIG. 1 may be include in a second subgroup.

In some embodiments, whether the request is granted or denied may be based on whether the count of available units for the customer or the customer subgroup is equal to or greater than the number of assigned units for the digital content.

In some embodiments, the request for access may be denied. For example, the number of available units associated with the customer or the customer subgroup may be less than the number of assigned units for the requested digital content and the request may be denied. In some embodiments, the provider may reject the request and may prevent the customer system, the requesting device, or both, from accessing to the content.

In some embodiments, the request for access may be granted. For example, the number of available units associated with the customer or the customer subgroup may be equal to or greater than the number of assigned units for the requested digital content and the request may be granted.

Although not shown separately, in some embodiments, granting the request may include charging, redeeming, or exchanging a number of available licensing units allocated to the customer system or the customer subgroup corresponding to the number of assigned units for the digital content object. For example, the license manager or provider may record the number of licensing units charged, may update the number available units associated with the customer system or the customer subgroup, or both. In some embodiments, the license manager or provider may record any change in charged units or available units in a log. In some embodiments, the number of available units for the customer system or the customer subgroup may be decreased in an amount equal to the number of assigned units for the digital content indicated in the request.

In some embodiments, granting the request may include determining whether to charge one or more of the available licensing units allocated to the customer system or the customer subgroup. For example, the provider or the licensing manager may determine the number of checked out units currently charged against the customer system or the customer subgroup, and may determine a number of licensing units to charge against the customer system or the customer subgroup based on a difference between the number of assigned units for the requested content and the number of currently checked out units for the customer or the customer subgroup. For example, the number of currently checked out units for the customer or the customer subgroup may be greater than the number of assigned units and granting the request may omit checking out available units. In another example, the number of currently checked out units for the customer or the customer subgroup may be less than the number of assigned units and granting the request may include checking out a number of available units equal to the difference between the number of assigned units and the number of currently checked out units.

In some embodiments, the requesting device may access the digital content in response to receiving a response granting the request at 350. For example, the requesting device may receive the requested content from the provider via the customer system. In some embodiments, the available units for the customer or the customer subgroup may be updated in response to the device accessing the content.

Although not shown separately, in some embodiments, the number of charged units may be returned to the customer system or the customer subgroup upon completion or termination of the access of the digital content.

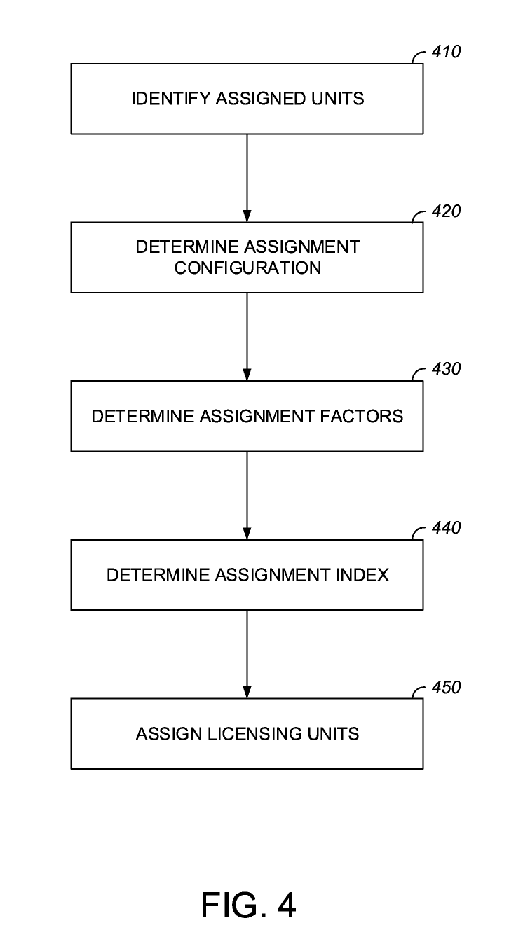

FIG. 4 is a flow diagram of an example of automated popularity-based pricing for digital content licensing in accordance with embodiments of this disclosure. Automated popularity-based pricing for digital content licensing may include assigning, or updating an assignment of, a number, count, or cardinality of licensing units for access to content, such as digital content. In some embodiments, automated popularity-based pricing for digital content licensing may include varying the number of the assigned licensed units associated with a digital content object over time based on factors, such as the popularity of the digital content object. For example, in some embodiments, popularity-based pricing may be determined based on a popularity index, which indicate the popularity of a digital content object and may be based on popularity factors for the digital content object. In some embodiments, automated popularity-based pricing for digital content licensing may be implemented in a communication system, such as the communication system 100 shown in FIG. 1. For example, automated popularity-based pricing for digital content licensing may be implemented in a provider, such as the content provider 120 shown in FIG. 1, in a licensing manager, such as the licensing manager 140 shown in FIG. 1, or in a combination of a provider and a licensing manager.

In some embodiments, automated popularity-based pricing for digital content licensing may include identifying a current cardinality of assigned units for a digital content object at 410, identifying an assignment configuration at 420, determining an assignment factor at 430, determining an assignment index at 440, assigning a cardinality of licensing units for the digital content object at 450, or a combination thereof. In some embodiments, automated popularity-based pricing for digital content licensing may be performed periodically. In some embodiments, automated popularity-based pricing for digital content licensing may be performed in response to a trigger, such as the receipt of a request to access a digital content object.

In some embodiments, a current cardinality of assigned units for a digital content object may be identified at 410. For example, the provider or licensing manager may identify a cardinality of licensing units previously assigned for the digital content object. In some embodiments, the digital content object may not have a current or previously assigned cardinality of licensing units.

In some embodiments, identifying the current cardinality of assigned units for a digital content object may include determining whether to update the cardinality of assigned units for the digital content object. For example, the licensing manager or content provider may determine whether the currently cardinality of licensing units assigned for the digital content object should be used. In some embodiments, the current number of licensing units may be used. In some embodiments, the cardinality of licensing units may be updated. For example, the cardinality of assigned units for a digital content object may be updated periodically.

In some embodiments, an assignment configuration may be determined at 420. In some embodiments, the assignment configuration may indicate metrics for generating or updating a licensing unit assignment for a digital content object. In some embodiments, an assignment configuration may indicate a condition for updating the assignment. For example, the assignment configuration may indicate that the assignment may be updated periodically, may indicate a corresponding period, and the assignment may be updated periodically based on the indicated period. For example, the assignment may be updated daily, weekly, monthly, quarterly, yearly, or based on some other suitable interval.

In another example, the assignment may be updated in response to a trigger, such as user input or new digital content objects being added to suite of digital content. In some embodiments, the assignment configuration may indicate one or more assignment factors for generating an assignment index that may be used to identify an assignment. In some embodiments, determining the assignment configuration may include identifying a previously generated assignment configuration.

In some embodiments, determining the assignment configuration may include generating an assignment configuration. In some embodiments, generating an assignment configuration may include identifying conditions for updating the assignment, identifying factors for determining the assignment index, weighting the factors, or identifying any other information relevant to determining a licensing unit assignment for digital content. In some embodiments, determining the assignment configuration may include identifying a minimum cardinality of assigned units, a maximum cardinality of assigned units, or both.

In some embodiments, assignment factors may be determined at 430. For example, the assignment configuration identified at 420 may include information indicating one or more assignment factors. In some embodiments, the popularity of digital content may be determined based on a customer base. In some implementations, the customer base may include customers that are capable of accessing the particular digital content through a licensing scheme or any subset of the customers that are capable of accessing the digital content. In some embodiments, popularity may be determined based on external data unrelated to customers within the licensing scheme, such as polls of select groups or third parties. For example, the external data may be based on a standardized or publically published popularity rating. The external data may also be a group of users on social networking sites or websites that allow for liking, ranking, rating, or discussion of the digital content. In some embodiments, a group of customers may share licensing units, and the customer base may be one or more of individual users within one or more of the customer groups.

In some embodiments, an assignment factor may indicate a number, count, or cardinality of unique users that accessed the digital content, which may be based on users associated with the customer, or a sub-group thereof, or with a group of customers, or with all customers. In some embodiments, an assignment factor may indicate a number, count, or cardinality of times the digital content was accessed by a user (access instances), which may be based on users associated with the customer, or a sub-group thereof, or with a group of customers, or with all customers. In some embodiments, an assignment factor may indicate the recency or age of the digital content. In some embodiments, an assignment factor may indicate a rating of the digital content, such as an average user rating, or a number of approval or like indications. In some embodiments, an assignment factor may indicate a social media effect of the digital content, such as popularity from a third-party social networking website. In some embodiments, an assignment factor may indicate a metric associated with a creator of the digital content. Such as a popularity metric, reach metric, or a reputation metric. Other suitable factors may be present in some embodiments, such as those based on both the customer base and external data such as data collected by third party services. In some embodiments, one or more factors may be scaled to a uniform scale, such as values from 0 to 100.

In some embodiments, an assignment index may be determined at 440. For example, the assignment index may be based on the popularity factors identified at 430. In some embodiments, the licensing manager, the provider, or a combination thereof, may determine the assignment index for a digital content object.

In some embodiments, determining the assignment index may include using an index function. For example, “a,b,c,d, . . . ” may indicate assignment factors, which may be factors indicative of popularity, and an index function f( ) for determining the assignment index may be expressed as the following:

{PIndex=f(a,b,c,d, . . . )}.

In some embodiments, the index function may be a linear or a non-linear regression function. In some examples the index function may be a weighted least squares linear regression function with weighted factors.

In some embodiments, the assignment index may be based on a number of times the digital content object has been accessed (plays or access instances). In some embodiments, the assignment index may be based on a count of actions related to the digital content in one or more social networks (likes), such as a number of comments or approvals for the digital content. In some embodiments, the assignment index may be based on an express rank or rating for the digital content (rank). In some embodiments, the rank may be expressed within a defined scale, such as within a range from 1 to 5, wherein a rank of 1 indicates the highest positive rating and a rank of 5 indicates the lowest rating. In some embodiments, the rank may be generated by the provider, the customer, or by a third party. In some embodiments, the assignment index may be based on a cardinality of licensing units allocated to a user, a customer, or a group or subgroup thereof (units).

In some embodiments, the assignment index may be based on a measure of the number of times the digital content is accessed per unique user (occurrences). In some embodiments, “occurrences” may be expressed as:

$$Occurrences = \frac{plays}{number of users} .$$

In some embodiments, the assignment index may be based on an amount of the digital content that is accessed (leave index). In some embodiments, “amount played” may indicate the amount of the digital content accessed, such as a number of minutes of the digital content, and “digital content amount” may indicate a total amount of the digital content, such as the number of minutes the digital content, and the “leave index” may be expressed as the following:

$$Leave index = 1 - \frac{amount played}{digital content amount} .$$

For example, the “leave index” may be close to 1 when a user accesses or plays a brief portion, such as the first few seconds, of the digital content, and the “leave index” may be 0 when a user accesses or plays all the digital content.

In some embodiments, the assignment index may be based on a cardinality (n) of digital content objects that are similar to the current digital content object. In some embodiments, the assignment index may be based on a number of times that the n similar digital content objects were accessed (plays similar object). In some embodiments, the assignment index may be based on a factor (cᵢ) associated with a respective similar object.

In an example, the current digital content object may be a song, and the n similar digital content objects may include digital content objects from an album that includes the current digital content object, or digital content objects authored by the same artist as the current digital content object. In another example, the current digital content object may be a movie, and the n similar digital content objects may be digital content objects associated with one or more entities, such as actors, directors, producers, studios, or the like, associated with the current digital content object.

In some embodiments, “a”, “b”, and “d” may indicate constant parameters, and determining the assignment index may be expressed as the following:

$$Assignment index = ( ( a \cdot plays + b \cdot {plays}^{2} ) \cdot ( 1 - leave index ) + {\sum }_{i = 1}^{n} {c}_{i} \cdot plays similar object ) \cdot units \cdot ( d - rank ) \cdot occurrences \cdot Log ( 1 + likings )$$

In some embodiments, the assignment index may be determined by a processor at the provider, or may be determined by a separate processor which is coupled to the provider through a communication network. In some embodiments, the assignment index determination may be based on the same formula and factors for all digital content. In some embodiments, the determination of the assignment index may be based upon factors or formulas that are unique to different types of digital content objects. For example, the assignment index may be determined based on a set of factors that is correlated to the type of content. In some embodiments, the set of factors may be based on genre, provider, creator, or owner of a digital content object.

In some embodiments, a cardinality of licensing units for the digital content object may be assigned at 450. In some embodiments, the number of license units assigned to a digital content object may vary over time, which may reflect changes in the assignment index. In some implementations, the licensing unit allocation based on the assignment index may be performed by a processor at the provider, or by a separate central processing unit or microprocessor which may be coupled to the content provider through a network.

In some embodiments, the cardinality of licensing units assigned for the digital content object may be limited to a value within the minimum and maximum number of assigned units, which may ensure that customers are charged between a minimum and maximum amount of units even in cases of extremely high and low popularity indexes. In some embodiments, a pricing curve may be set to determine the licensing unit assignment, and may be based upon an initial assignment index, one or more of the assignment factors, the minimum and maximum number of assigned units, or a combination thereof. In some embodiments, the curve, or a representation thereof, may be stored, and a subsequent assignment update may identify a cardinality of assigned units based on the stored curve.

Although not shown separately, automated popularity-based pricing for digital content licensing may include communicating a change in the cardinality of assigned units for digital content to a customer, such as the customer system 110 shown in FIG. 1. For example, the licensing manager, the provider, or a combination thereof, may generate and transmit a message indicating the change to the customer. In some embodiments, the updated cardinality of assigned units may be communicated in response to the change in the number of assigned units. In some embodiments, the number of assigned units for a digital content object may be updated concurrently with customer access to the digital content object, and the updated cardinality of assigned units may be communicated to the customer in response to the completion of access to the digital content object.

In some embodiments, digital content that is being accessed concurrently with a change in the assigned units for the content may continue to be accessed based on the cardinality of assigned units before the update. In some embodiments, the number of charged units for accessing digital content concurrently with a change in the assigned units for the content may be adjusted by an amount corresponding to the difference between the cardinality of assigned units before the update and the cardinality of assigned units after the update. In some embodiments, digital content that is being accessed concurrently with a change in the assigned units for the content may be in a paused mode and the assigned units may be updated after a paused time is greater than a pause period threshold. In some embodiments, the customer system may present a notification, such as a text notification, a graphical notification, or an audio notification, indicating that the assigned units for a digital content object currently being accessed or in a paused state has been updated.

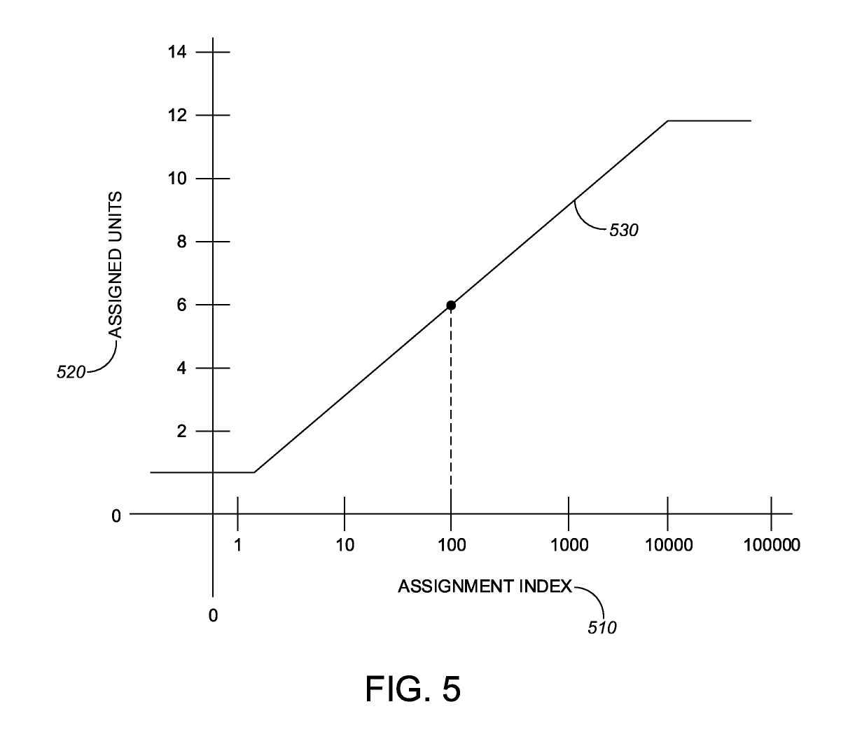

FIG. 5 is a graph showing an example of a relationship between assigned units and an assignment index in accordance with embodiments of this disclosure. As shown, the vertical axis indicates a value of a cardinality of assigned units 520, and the horizontal axis indicates a value of an assignment index 510. For example, the horizontal axis may indicate a value of a popularity index. Although the popularity index is shown as having values from 0 to 100,000, any range of values representing popularity may be used. Similarly, although FIG. 5 shows assigned units from 0 to 14, any number of assigned units may be used.

As shown, the cardinality of assigned units corresponding to respective assignment index values is shown by a curve 530. For example, higher values of the assignment index may correlate to a greater number of assigned units. In the example shown in FIG. 5, the curve 530 may indicate that an assignment index of 100 may correlate to six (6) assigned units. In an example, “a”, “b”, and “c” may indicate constant coefficients, and the curve 530 may be expressed as the following:

$$Units = max ( 1 , min ( \begin{matrix}12 , Log ( a + b \cdot popularity index + \\ c \cdot popularity {index}^{2} + \\ d \cdot popularity {index}^{4} )\end{matrix} ) )$$

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A method comprising:
receiving a request for access to content, the request for access indicating a customer account;
determining, by a processor in response to instructions stored on a non-transitory computer readable medium, a cardinality of assigned units for the content based on an assignment index for the content;
identifying a cardinality of available licensing units allocated to the customer account;
determining whether the cardinality of the assigned units is within the cardinality of the available licensing units; and
outputting a response, wherein outputting the response includes:
indicating that the request is granted, on a condition that the cardinality of the assigned units is within the cardinality of the available licensing units, and
indicating that the request is denied, on a condition that the cardinality of the assigned units exceeds the cardinality of the available licensing units.

2. The method of claim 1, wherein the assignment index is a popularity based index.

3. The method of claim 1, wherein determining the cardinality of the assigned units includes:
determining whether the content is associated with an assignment configuration;
on a condition that the content is not associated with an assignment configuration, generating an assignment configuration; and
on a condition that the content is associated with an assignment configuration:
identifying a previously assigned cardinality of assigned units for the content, and
determining whether to update the previously assigned cardinality of assigned units.

4. The method of claim 3, wherein generating the assignment configuration includes identifying an assignment factor for determining the assignment index or identifying a period for generating the assignment index.

5. The method of claim 3, wherein determining the cardinality of the assigned units includes updating the previously assigned cardinality of assigned units on a condition that a period indicated by the assignment configuration associated with the content has expired.

6. The method of claim 1, wherein determining the cardinality of the assigned units includes determining a plurality of assignment factors for the content.

7. The method of claim 6, wherein the plurality of assignment factors includes a cardinality of unique users that accessed the content, a cardinality of access instances for the content by users, a recency of the content, a rating of the content, or a social media indicator for the content.

8. The method of claim 7, wherein the users are associated with the customer, with a subgroup of the customer, or with a plurality of customers that includes the customer.

9. The method of claim 1, wherein determining the cardinality of the assigned units includes determining the assignment index.

10. The method of claim 9, wherein determining the assignment index includes determining the assignment index based on a cardinality of access instances for the content, a cardinality of actions related to the content, a rank for the content, the cardinality of licensing units allocated to the customer, a cardinality of access instances per user, an average amount of accessed content for the content, and a cardinality of a plurality of similar content.

11. An apparatus comprising:
a non-transitory computer readable memory; and
a processor configured to execute instructions stored on the memory to:
receive a request for access to content, the request for access indicating a customer account;
determine a cardinality of assigned units for the content based on an assignment index for the content;
identify a cardinality of available licensing units allocated to the customer account;
determine whether the cardinality of the assigned units is within the cardinality of the available licensing units; and
output a response, wherein outputting the response includes:
indicating that the request is granted, on a condition that the cardinality of the assigned units is within the cardinality of the available licensing units, and
indicating that the request is denied, on a condition that the cardinality of the assigned units exceeds the cardinality of the available licensing units.

12. The apparatus of claim 11, wherein the assignment index is a popularity based index.

13. The apparatus of claim 11, wherein the processor configured to execute instructions stored on the memory to determine the cardinality of the assigned units by:
determining whether the content is associated with an assignment configuration;
on a condition that the content is not associated with an assignment configuration, generating an assignment configuration; and
on a condition that the content is associated with an assignment configuration:
identifying a previously assigned cardinality of assigned units for the content, and
determining whether to update the previously assigned cardinality of assigned units.

14. The apparatus of claim 13, wherein the processor configured to execute instructions stored on the memory to generate the assignment configuration by identifying an assignment factor for determining the assignment index or identifying a period for generating the assignment index.

15. The apparatus of claim 13, wherein the processor configured to execute instructions stored on the memory to determine the cardinality of the assigned units by updating the previously assigned cardinality of assigned units on a condition that a period indicated by the assignment configuration associated with the content has expired.

16. The apparatus of claim 11, wherein the processor configured to execute instructions stored on the memory to determine the cardinality of the assigned units by determining a plurality of assignment factors for the content.

17. The apparatus of claim 17, wherein the plurality of assignment factors includes a cardinality of unique users that accessed the content, a cardinality of access instances for the content by users, a recency of the content, a rating of the content, or a social media indicator for the content.

18. The apparatus of claim 17, wherein the users are associated with the customer, with a subgroup of the customer, or with a plurality of customers that includes the customer.

19. The apparatus of claim 11, wherein determining the cardinality of the assigned units includes determining the assignment index based on a cardinality of access instances for the content, a cardinality of actions related to the content, a rank for the content, the cardinality of licensing units allocated to the customer, a cardinality of access instances per user, an average amount of accessed content for the content, and a cardinality of a plurality of similar content.

20. A method comprising:
transmitting, by a processor in response to instructions stored on a non-transitory computer readable medium, a request for access to content, the request for access indicating a customer account; and
receiving a response, wherein receiving the response includes:
identifying, in the response, an indication that the request is granted, on a condition that a cardinality of assigned units for the content is within a cardinality of available licensing units allocated to the customer account, wherein the cardinality of the assigned units for the content is based on a popularity based assignment index.
